(19) United States
(12) Patent Application Publication
(10) Pub. No.: US 2010/0269549 A1
(43) Pub. Date: Oct. 28, 2010

(54) HAND RESTRAINT DEVICE

(76) Inventor: David Isaacs, Fort Lauderdale, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/808,786

(22) PCT Filed: Dec. 17, 2008
(86) PCT No.: PCT/US08/87171

§ 371 Date: Jun. 17, 2010

Related U.S. Application Data
(60) Provisional application No. 61/014,397, filed on Dec. 17, 2007.

(51) Int. Cl. E05B 75/00; A41D 19/01

(52) U.S. Cl. 70/16; 2/158

(57) ABSTRACT

A hand restraint device consisting of a pair of hand restraint mitts which are used for restraining the hands of an individual to prevent them from using their hands in undesired ways. The mitts can be used in conjunction with handcuffs. The mitts can be placed on the individual either before or after the handcuffs are secured to the individual. The mitts are designed to open up on the bottom and one side of the mitt which allows quick and easy placement on the hand of the individual. A cable tie or strap which has been placed through two pockets, one on each side, close to the bottom of the mitt can be quickly and easily pulled to secure the hand within the mitt. Under tension from the tie or strap, the mitt completely encases the hand up to the wrist which prevents the use of the hand or fingers in undesired ways. When the cable tie or strap is pulled to secure the hand, the hand chamber, which the hand is in, bows out under the tension of the strap to create an open pocket for the hand to float inside. This provides a very comfortable open area for the hand and fingers to reside in which allows room for movement within the mitt while still effectively keeping the hand secured.

### CROSS-REFERENCE TO RELATED APPLICATIONS

This application claims the benefit of Provisional Application 61/014,397, filed Dec. 17, 2007, which is incorporated herein by reference.

### FIELD OF THE INVENTION

This invention relates to a device for restraining the hands of a handcuffed person, such as by law enforcement and security officers. This invention prevents the individual from using their hands to cause injury, to acquire a weapon, to escape from the handcuffs, or to cause other serious consequences by their use of their free hands.

### BACKGROUND OF THE INVENTION

Law enforcement and security officers generally use either handcuffs or disposable restraints typically made of plastic as the restraint device to secure the subject. The problem that exists is that the handcuffed subject's hands are free to move about or grab objects so the subject can cause serious consequences if given an opportunistic moment to use those hands.

There are devices previously patented and the subject of published patent applications that claim to correct this problem by encasing or restraining the hands and fingers. These fall into two groups. One group of patents uses a pouch or bag to encase both hands, and generally also encase the handcuffs. These include U.S. Pat. No. 5,343,562; U.S. Pat. No. 4,741,051; U.S. Pat. No. 5,349,966; U.S. Pat. No. 4,469,096; U.S. Pat. No. 5,031,641; U.S. Published Patent App. No. 2005/0172974 A1; and U.S. Published Patent App. No. 2007/0039622 A1.

A second group of patents uses a device to encase each hand individually. These include U.S. Pat. No. 5,230,351; U.S. Pat. No. 4,024,863; and U.S. Pat. No. 5,551,086. The devices specified in all these patents in both groups indicated above have significant deficiencies in design which would make them undesirable for their intended use by law enforcement or security officers. The deficiencies of each of these devices include one of more of the following problems: Either the device is too bulky or large in size; too cumbersome or hard to use; too slow to secure the subject; not fully effective in securing the subject's hands; the device is too complex; the device is too expensive to make; the device is too uncomfortable because of pressure or excessive constraints on the hands or fingers; or the device places the hands, wrists, or arms in an uncomfortable or an immobile position.

For a device of this type to be desirable for law enforcement and security officers, not only does the device have to effectively secure the subject's hands but it must do so quickly and with relative ease as the subject may resist the installation of the device on their hands, especially when trying to install a device which secures both hands at once. The device should be comfortable for the subject and should not position the hands, wrists, or arms in an uncomfortable position nor should it unnaturally bind the hands or fingers as the subject may have to endure the use of the device for hours during long distance transport. In addition, the cost of the device must be reasonable and the device must not be large or cumbersome for the storage or use of the device.

### SUMMARY OF THE INVENTION

The design of this new device has none of the deficiencies mentioned in the preceding paragraph and is a major improvement over all of those devices which have been patented in the past. The unique design of this mitt allows it to lay flat for compact storage. The design allows it to be loaded with different types of security straps so the officer can choose the best type of security strap in each situation. This includes inexpensive non-releasable cable ties which require cutting to be removed which are ideal to be used when the subject is around others who may attempt to release the mitts or when subject must be left unguarded for any length of time. The releasable cable ties can be instantly released and are inexpensive which can be reused many times but cannot be released by the subject secured by the device. This type of security strap is ideal under most circumstances where the subject is under guard. There are handcuff key lock security straps which are more costly than the previous two straps which can be reused many times and are released using a standard handcuff key. The mitts loaded with the straps are ready for use. The mitts are simply slipped onto the subject's hands and each hand is secured by pulling the end of the strap to tighten it which takes a total time of less than 5 seconds by an officer, with the officer using just one hand to secure the mitt. This is highly desirable under the conditions in which law enforcement officers must operate. The simple design of the mitt allows it to be manufactured at a low cost which is important because of the budget constraints of most law enforcement organizations. The mitt also incorporates a pair of D-rings, one on each side, which can be used to secure both mitts together, or multiple subjects together, or can be used to secure a mitt to a fixture to prevent the subject from leaving a controlled area.

The design of the mitt is based on the need for the mitt to be flexible so that it can change configurations and be strong so that it can secure the hand effectively. The mitt has been optimized in each of the following three configurations. The mitt is designed to lay flat in a storage configuration which can hold the security strap inside the mitt around its interior perimeter; it is designed to have the bottom and side of the mitt held open by the tension of the security strap so the mitt can readily accept the hand and is able to quickly secure the hand in a strap loaded configuration; and it is designed to change shape in a hand secured configuration. The mitt is in the hand secured configuration once the hand is inserted and the strap is pulled securing the subject. The mitt is designed to change to this configuration as the strap is tightened. The hand chamber bows out under the tension of the strap creating an open pocket for the hand to float inside. The wrist area is designed to bow out to the approximate shape of a wrist. The hand that is encased has freedom of movement without pressure on it and fingers can be moved as desired within the mitt. The thumb area is extra wide which gives the thumb freedom of movement within the mitt. The wrist has slight pressure or light snug feeling to it. Even though the mitt does not feel tight or constraining, the mitt cannot be removed without someone else available to release the strap. The mitt is designed to be comfortable and to be able to be worn continuously for hours.

### BRIEF DESCRIPTION OF THE DRAWINGS

A better understanding of the present invention can be had by referring to the accompanying drawings in which;

FIG. 1 is a perspective view of a pair of mitts of the present invention in use;

FIG. 2 is an elevational view of a mitt shown in FIG. 1;

FIG. 3 is an enlarged cross sectional view of the mitt of the present invention taken substantially along line 3-3 of FIG. 2; and

FIG. 4 an elevational view of a mitt of the present invention being positioned on the hand of a user;

### DETAILED DESCRIPTION OF THE PREFERRED EMBODIMENTS

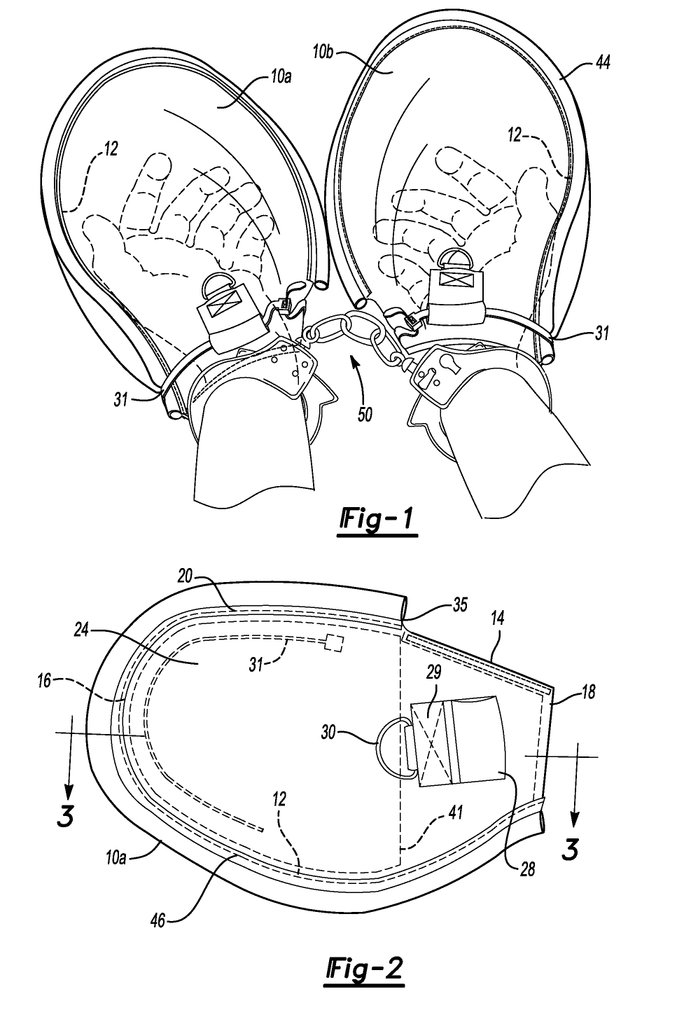

Referring to FIG. 1, a perspective view of a pair of hand restraint mitt 10a and 10b of the present invention is shown. The mitts 10a and 10b are mirror images of each other and each may be about 12″ tall by 8″ wide and with an almost elliptical appearance although the mitt 10a, 10b is not symmetrical. The dimensions of the mitts 10a and 10b can vary considerably in size or shape and still be functional. The size and shape of the mitt 10a, 10b is a compromise between the ability to fit the largest hand possible and the maximum size that would not be too big or overburdening. More than one size can be made with an extra-large size that could encompass the largest hand possible. The mitt 10a, 10b is elongated outward to provide extra room for a thumb area 12.

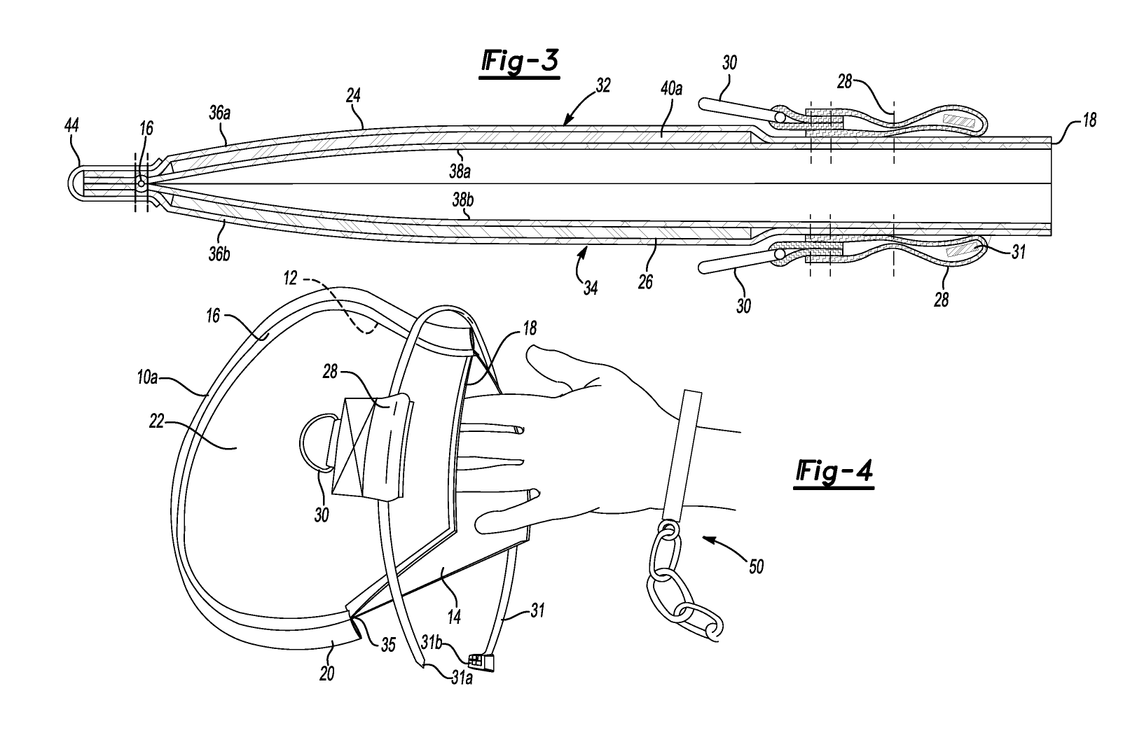

As best seen in FIG. 4 the side of the mitt 10a, 10b opposite the thumb area 12 is open as at 14. A reinforcing wire 16 is sewn along the side on each side of the mitt 10a, 10b. The wire 16 preferably ends about a third of the way up from the bottom 18 of the mitt 10a, 10b on the side 20 opposite the thumb area 12 to define the opening 14. On the back 22 and the front 24 of each mitt 10a, 10b near the bottom 18 a cable tie loop 28, a pocket 29 and D-ring assembly 30 are provided. A strap 31 is provided to extend through the loops 28 and when tightened secure the mitt 10a, 10b to the wrist of the handcuffed person preferably below the handcuffs 50 so as not to interfere with the locking and unlocking of the handcuffs 50. Although the strap 31 is illustrated as being in the form of a conventional cable tie other straps can be used to secure the mitt 10a, 10b in place. It is preferred that the strap 31 be formed of a bendable material having a memory as do conventional cable ties for a reason that will become apparent as the description proceeds

Each mitt 10a, 10b is comprised of half shells or panels 32 and 34. The half shells 32 and 34 are mirror images of each other but otherwise identical in construction. As best seen in FIG. 3 each of the half-shells 32 and 34 is comprised of three layers. The outside of the mitt 10a, 10b is the fabric outer layer 36a, 36b. The inside of the mitt is the inner layer 38a, 38b which contacts the hand of the secured subject. Between these two layers 36a, 36b and 38a, 38b is the middle layer 40a, 40b which is the security layer and which provides the rigidity to the mitt 10a, 10b.

The outer layer 36a, 36b is made from a durable fabric or other material, which can include canvas, or cotton, or a type of synthetic fiber such as nylon. The outer layer 36a, 36b provides the finished look to the mitt 10a, 10b, the surface to hold the other layers together; and is the outer mounting surface for the strap loops 28, the pockets 29 the D-rings 30, and the wire 16 reinforcements. The fabric is trimmed to size using a template leaving a lip at the side and bottom to make the side and bottom hems.

The inner layer 38a, 38b is made from a thin foam rubber sheet, or other material which is durable and provides a comfortable surface for the secured hand to rest against. It also adds some reinforcement to the mitt, especially the bottom section of the mitt which does not have the middle security layer 40a, 40b. The foam rubber is trimmed to size using a template

The middle layer 40a, 40b is the security layer which is made from a vinyl sheet, or other material which is durable, strong, and provides enough rigidity to provide the strength to keep the hand secure but enough flexibility to bow out under the tension of the strap 31 to open up the hand chamber so the hand is not constrained inside the mitt 10a, 10b. The material must be properly selected to balance the rigidity and flexibility characteristics for the mitt 10a, 10b to properly function. The vinyl sheets come in many different strengths of rigidity so a trial must be done to select for proper functioning of the mitt 10a 10b. The middle layer 40a, 40b has a slightly smaller perimeter than the other two layers so the stitching around the perimeter of the mitt is outside of the perimeter of the middle layer 40a, 40b. The middle layer 40a, 40b does not extend to the bottom of the mitt 10a, 10b. As best seen in FIG. 2 the middle layer 40a, 40b stops just above the pivot point 35 on the open side and angles down slightly along an edge 41 to the thumb side 12 of the mitt 10a, 10b. The bottom 18 of the mitt 10a, 10b does not incorporate the middle layer 40a, 40b so the bottom 18 of the mitt 10a, 10b can open without the rigidity that this layer provides to the top of the mitt 10a, 10b. The vinyl is trimmed to size using a template.

The pivot point 35 is formed by sewing multiple times back and forth to create a very strong reinforcement stitch which will not fatigue or break after hundreds of flexures. An adhesive foam tape 44 is placed around the edge of the mitt 10a, 10b to cover the unfinished edge of the mitt 10a, 10b and the edge stitching 46 and wire 16 on both sides of the mitt 10a, 10b to provide extra cushioning around the edge of the mitt 10a, 10b The foam tape 44 may be additionally glued or sewn to secure it in a stronger manner.

The mitt 10a, 10b has three different configurations. In each configuration, the mitt 10a, 10b has different physical properties and appearances which have advantages for each state of the mitt 10a, 10b.

In a storage configuration, as shown in FIG. 3 the mitt 10a, 10b is designed to lay totally flat for convenient storage. The strap or tie 31 is preferably stored inside the mitt 10a, 10b positioned around the inside perimeter. This provides a convenient storage method and the mitt 10a, 10b is readily available for use.

To prepare the mitt 10a, 10b for use, the strap or tie 31 is placed through the loop 28 on each side of the mitt 10a, 10b and the tip 31a of the tie 31 (FIG. 4) is inserted into the lock mechanism 31b. This is the strap loaded configuration. This procedure takes about 10 seconds. The mitt 10a, 10b is ready for use in the strap loaded configuration which is designed to do the following two things: First, the strap tension provides the force to hold the bottom 14 of the mitt 10a, 10b open providing easy entrance of the hand without having to physically open it. Second, the mitt 10a, 10b becomes ready to secure the hand. The hand can be inserted and secured in this configuration in under 5 seconds.

The mitt 10a, 10b is in the hand secured configuration once the hand is inserted and the strap 31 is pulled. The mitt 10a, 10b is designed to change configuration as the strap 31 is tightened. The hand chamber bows out under the tension of the strap 31 creating an open pocket for the hand to float inside. The wrist area is designed to bow out to the approximate shape of a wrist. The hand that is encased has freedom of movement without pressure on it and fingers can be moved as desired within the mitt 10a 10b. The thumb area 12 is extra wide which gives the thumb freedom of movement within the mitt 10a, 10b. The wrist has slight pressure or light snug feeling to it. Even though the mitt 10a, 10b does not feel tight or constraining, the mitt 10a, 10b cannot be removed without someone else available to unlock the strap 31. The mitt 10a, 10b is designed to be comfortable and to be able to be worn continuously for hours.

To use the mitt 10a, 10b, it should be placed into the strap loaded configuration. The mitt 10a, 10b is positioned to the side where the thumb enters the mitt 10a, 10b at the elongated thumb area 12. To secure a subject, the mitt 10a, 10b, which already has an open hand entrance due to the tension of the security strap 31, is slipped onto the hand of the subject using one hand by the officer and then the officer uses the same hand to pull the security strap 31 to provide a snug fit around the wrist. The subject is secured at this point. Finally, the end of the strap 31 can be slipped through the cable tie pocket 28 to tuck away the end of the security strap 31 so there is no protruding strap end 31a.

It will be understood that the above described preferred embodiment of the device and the method described herein are merely illustrative of applications of the principles of this invention and many other embodiments and modifications may be made without departing from the spirit and scope of the invention as defined in the claims.

1. A restraint for a person's hands comprising;
a mitt formed of a pair of spaced apart panels each having outer edges;
means joining said panels one to the other along a portion of said outer edges forming an open bottom at one end and a closed top opposite said bottom and to lay substantially flat when not in use;
said panels being formed of at least two layers with a first outer layer formed of a fabric and a second layer disposed inwardly of said first layer and formed of a material more rigid than said first outer layer.

2. The restraint as defined in claim 1 and in which said second layer is formed of a vinyl material.

3. The restraint as defined in claim 2 and in which said panels include a third layer disposed inwardly of said second layer.

4. The restraint as defined in claim 3 and in which said first and said third layers extend substantially to said bottom of said panels and said second layer extends short of said bottom to facilitate opening of said mitt

5. The restraint as defined in claim 1 and in which said mitt includes a loop fixed to said outer layer of said panels and a lockable strap attachable to said panels through said loops.

6. The restraint as defined in claim 5 and in which said strap is formed of a bendable material having a memory whereby insertion of said strap into said loops causes said strap to urge said panels to separate to urge said bottom to an open position.

7. The restraint as defined in claim 1 and including a pair of said mitts, one for each hand.

8. The restraint as defined in claim 7 and including means on each of said mitts for locking said mitts together.

9. A restraint for a person's hands wherein the wrists of the person are handcuffed said restraint comprising;
a pair of mitts one for each hand of the handcuffed person, each of said mitts being formed of a pair of spaced apart panels each of said panels having outer edges;
means joining said panels one to the other along a portion of said outer edges forming an open bottom at one end and a closed top opposite said bottom and to lay substantially flat when not in use;
said panels being formed of at least three layers with a first outer layer formed of a fabric, a second layer disposed inwardly of said first layer and formed of a material more rigid than said first outer layer and a third layer disposed inwardly of said second layer and
said first and said third layers extending substantially to said bottom of said panels and said second layer extending short of said bottom to facilitate opening of said mitt.

10. The restraint as defined in claim 9 and in which each of said mitts includes a loop fixed to said outer layer of said panels and a lockable strap attachable to said panels through said loops; and
said strap being formed of a bendable material having a memory whereby insertion of said strap into said loops causes said strap to urge said panels to separate to urge said bottom to an open position.
